(19) United States
(12) Patent Application Publication
(10) Pub. No.: US 2007/0140088 A1
(43) Pub. Date: Jun. 21, 2007

(54) Evaluating apparatus and evaluating method

(76) Inventors: Yasumori Hino, Nara (JP); Takeo Kanamori, Osaka (JP)

Correspondence Address: MARK D. SARALINO (MEI);RENNER, OTTO, BOISSELLE & SKLAR, LLP, 1621 EUCLID AVENUE, 19TH FLOOR, CLEVELAND, OH, 44115, US

(21) Appl. No.: 10/595,239

(22) PCT Filed: Sep. 29, 2004
(86) PCT No.: PCT/JP04/14711

§ 371 Date: Dec. 19, 2006

(30) Foreign Application Priority Data
Sep. 30, 2003 (JP) 2003-342107

(51) Int. Cl. G11B 20/10

(52) U.S. Cl. 369/59.22; 369/124.07

(57) ABSTRACT

The evaluating apparatus of the present invention includes: a digital filter for filtering a signal in according with one or more tap coefficients of the digital filter. The evaluating apparatus further includes: a detecting section for detecting an index to be used for evaluating quality of the signal based on the filtered signal; and a controlling section for controlling the one ox more tap coefficients of the digital filter to be within a pre-determined range such that a value of the detected index includes an optimal value of the index.

### TECHNICAL FIELD

The present invention relates to signal processing for decoding original digital information recorded on a recording medium using a maximum likelihood decoding method. In particular, the present invention relates to an apparatus and a method for optimally demodulating a signal based on the evaluation of the quality of the signal.

### BACKGROUND ART

Conventionally, a jitter has been used as an index value for evaluating quality of reproduction signals However, in the recent signal processing methods which are based on a PRML (partial response maximum likelihood), the correlation between a jitter and error rate is low. Consequentially, in the recent signal processing methods, an evaluate value called DMSAM (d-Minimum Sequenced Amplitude Margin) is used, so the DMSAM have a good correlation with the error rate of the decoded signal. The details of the DMSAM value will be described later.

FIG. 11 shows the configuration of a reproduction signal quality evaluating apparatus 400 according to a conventional technique. The reproduction signal quality evaluating apparatus 400 is disclosed in Reference 1 (the Japanese Laid-Open Publication No. 10-21651 (page 6 and FIG. 6)).

The reproduction signal quality evaluating apparatus 400 uses a DMSAM value as an index for evaluating quality of reproduction signals.

The reproduction signal quality evaluating apparatus 400 includes a data generating unit 1101 for generating data; a recording/reproduction apparatus 1102 for performing recording/reproduction of data; a maximum likelihood decoding unit 1103 for decoding the reproduced signal to the decoded data sequence; a synchronization pattern detecting unit 1104 for detecting a synchronization pattern from the decoded data sequence; a recording state detecting unit 1105 for detecting a data sequence, which includes a path having the shortest Euclidean distance, among the decoded data sequence; a standard deviation calculating unit 1106; and a smallest value determining unit 1107.

The standard deviation calculating unit 1106 calculates (σ_Δm)/(μ_Δm) based on a standard deviation (σ_Δm) of the differences between selected paths and unselected paths in the demodulation performed by the maximum likelihood decoding unit 1103 on the data sequence including the path having the shortest Euclidian distance and an average (μ_Δm) of the differences between the selected paths and the unselected paths. The smallest value determining unit 1107 determines the smallest value of (σ_Δm)/(μ_Δm). The value (σ_Δm)/(μ_Δm) indicates the quality of the reproduction signal.

The maximum likelihood decoding unit 1103 includes an adaptive equalizing filter. The adaptive equalizing filter is normally configured with an FIR filter such that linear distortion in reproduction signals can be removed. The adaptive equalizing filter keeps to minimize the linear distortion, even if the reproduction condition of the recording/reproduction apparatus changes.

The adapting method used by the adaptive equalizing filter is, for example, the LMS (Least Mean Square) method. According to the LMS method, filter coefficients are updated based on the amount of difference between an output from the adaptive equalizing filter and a target value. The LMS method is widely used because the algorithm is simple and also the convergence characteristics are good.

However, when an abnormal signal due to a signal loss or the like is input to the reproduction signal quality evaluating apparatus 400, the output from the adaptive equalizing filter diverges.

Further, the characteristics of the FIR filter vary in an extremely wide range when the coefficients of the FIR filter are altered. As a result, the adaptive equalizing filter included in the reproduction signal quality evaluating apparatus 400 corrects the output from the adaptive equalizing filter even if the individual differences among recording mediums are large. Thus, it is not possible to use a DMSAM value as an index for evaluating the signal quality of the recording medium.

The present invention is made in view of the problems described above. One of the purposes of the present invention is to provide an evaluating apparatus and an evaluating method which establishes a stable reproduction system by limiting a control range of the filter characteristics (the tap coefficients) of a digital filter, and to provide an evaluating apparatus and an evaluating method in which it is possible to use an index for evaluating signal quality in order to ensure stable characteristics of recording medium.

### DISCLOSURE OF THE INVENTION

The evaluating apparatus of the present invention includes a digital filter for filtering a signal in accordance with one or more tap coefficients of the digital filter. The evaluating apparatus further includes: a detecting section for detecting an index to be used for evaluating quality of the signal based on the filtered signal; and a controlling section for controlling the one or more tap coefficients of the digital filter to be within a pre-determined range such that a value of the detected index includes an optimal value of the index, thereby achieving the purpose of the present invention described above.

In the evaluating apparatus, it is possible that the digital filter includes a plurality of taps, and the controlling section controls a plurality of tap coefficients of the plurality of taps such that the plurality of tap coefficients are symmetrical.

The evaluating apparatus may further include: a maximum likelihood decoding section for performing a maximum likelihood decoding on the filtered signal and for generating a decoded signal indicating a result of the maximum likelihood decoding. In the evaluating apparatus, it is possible that the detecting section detects the index based on the filtered signal and the decoded signal, the digital filter includes a first tap, a second tap, a third tap, a fourth tap, and a fifth tap, and the controlling section controls tap coefficient k₀ of the first tap, tap coefficient k₁ of the second tap, tap coefficient k₂ of the third tap, tap coefficient k₃ of the fourth tap, and tap coefficient k₄ of the fifth tap, in accordance with the following Expressions 1, 2, and 3:

$$Expression 1 \text{:}$$

$${k}_{0} = {k}_{4} = \frac{1}{6 + 2 ( \frac{1}{r} + r ) + {r}^{2} + \frac{1}{{r}^{2}}}$$

$$Expression 2 \text{:}$$

$${k}_{1} = {k}_{3} = \frac{2 ( \frac{1}{r} + r )}{6 + 2 ( \frac{1}{r} + r ) + {r}^{2} + \frac{1}{{r}^{2}}}$$

$$Expression 3 \text{:}$$

$${k}_{2} = \frac{4 + {r}^{2} + \frac{1}{{r}^{2}}}{6 + 2 ( \frac{1}{r} + r ) + {r}^{2} + \frac{1}{{r}^{2}}}$$

where a frequency characteristic of the digital filter is controlled by r parameter.

In the evaluating apparatus, it is possible that a relationship of 0.21≦r≦0.27 is satisfied.

The evaluating method of the present invention includes the steps of: filtering a signal in accordance with one or more tap coefficients of a digital filter; detecting an index to be used for evaluating quality of the signal based on the filtered signal; and controlling the one or more tap coefficients of the digital filter to be within a predetermined range such that the detected index includes an optimal value of the index.

### BRIEF DESCRIPTION OF THE DRAWINGS

FIG. 1 is a diagram showing a configuration of the reproduction apparatus 100 according to embodiment 1 of the present invention.

FIG. 2 is a diagram showing state transitions of PR (1, 2, 2, 1) system with RLL (1,7) code.

FIG. 3 is a diagram showing a configuration of a Viterbi decoding unit 110.

FIG. 4 is a diagram showing a configuration of a DMSAM detecting unit 111.

FIG. 5 is a diagram showing a configuration of an FIR filter 108.

FIG. 6 is a diagram showing the filter characteristics of the FIR filter 108 on a z-plane.

FIG. 7 is a diagram showing a relationship between the filter characteristics of the FIR filter 108 and a DMSAM value.

FIG. 8 is a diagram showing the frequency characteristics of the FIR filter 108.

FIG. 9 is a diagram showing a configuration of the reproduction apparatus 200 according to embodiment 2 of the present invention.

FIG. 10 is a diagram showing a configuration of an FIR filter 901.

FIG. 11 is a diagram showing a configuration of a conventional evaluating apparatus 400 for evaluating a quality of a reproduction signal.

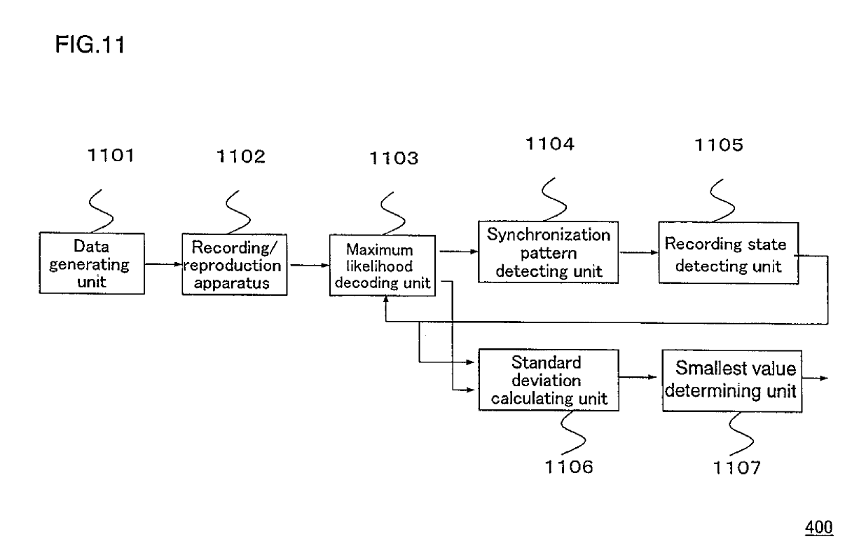

### BEST MODE FOR CARRYING OUT THE INVENTION

Hereinafter, embodiments of the present invention will be described below with reference to the drawings.

### Embodiment 1

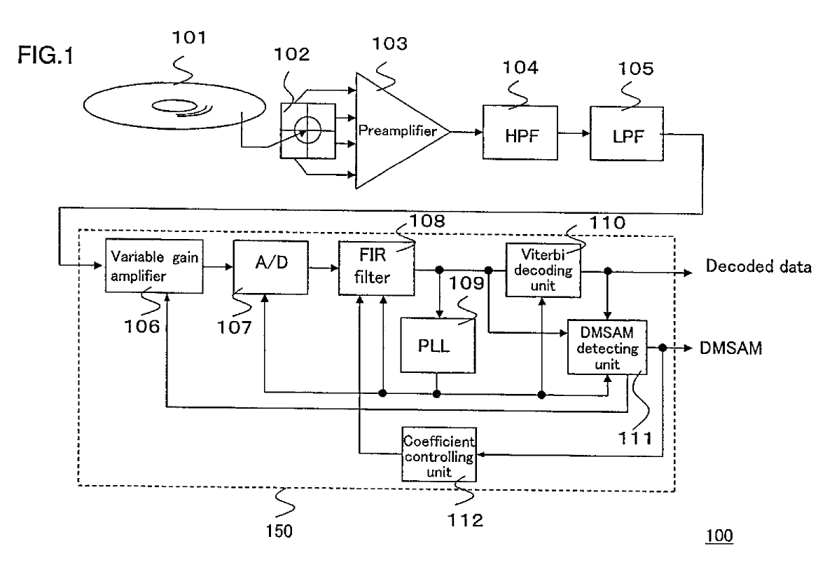

FIG. 1 shows a configuration of a reproduction apparatus 100 according to Embodiment 1 of the present invention. The reproduction apparatus 100 is configured so that an optical disc 101 can be inserted therein.

The reproduction apparatus 100 includes a PIN diode 102 for detecting portions of a reflection beam reflected by the optical disc 101 on the respective four divided areas, a preamplifier 103 for adding the portions of the reflection beam detected on the respective four divided areas, a high pass filter 104 having a cutoff frequency of 10 kHz, a Butterworth low pass filter 105 having a cutoff frequency of 30 MHz, and an evaluating apparatus 150.

The evaluating apparatus 150 includes a variable gain amplifier 106 for adjusting the amplitude of an analog signal, an A/D converter 107 for converting the analog signal into a digital signal, an FIR filter 108 for filtering the digital signal in accordance with tap coefficients in order to correct distortion in the digital signal, a PLL 109 for synchronizing the digital signal with a channel clock, a Viterbi decoding unit 110 for performing a maximum likelihood decoding on the filtered signal and generating a decoded signal indicating the result of the maximum likelihood decoding, a DMSAM detecting unit 111 for detecting a DMSAM value based on the filtered signal and the decoded signal, and a coefficient controlling unit 112 for controlling the tap coefficients of the FIR filter 108 within a predetermined range such that the DMSAM value includes an optimal DMSAM value.

For example, the DMSAM detecting unit 111 detects a DMSAM value based on metric differences among the plurality of specific paths. The coefficient controlling unit 112 controls the coefficients of the FIR filter 108 such that the DMSAM value is minimized.

Hereinafter, the operation of the reproduction apparatus 100 according to Embodiment 1 of the present invention will be described below with reference to FIG. 1. In this embodiment, the RLL (1, 7) modulation is used as a modulation method for recording, the PR and Viterbi decoder is used for reproduction, and PR type is PR (1, 2, 2, 1).

The reflection beam reflected by the optical disc 101 is detected by the PIN diode 102. The reflection beam is detected on the respective four divided areas in order to perform focusing control and tracking control (any control system for the focusing control and/or the tracking control is not shown in FIG. 1). The PIN diode 102 generates four types of signals. These four types of signals are added to each other and amplified to a desired level by the preamplifier 103. The high pass filter 104 removes low frequency noise from the output of the preamplifier 103. The low pass filter 105 removes high frequency noise from the output of the preamplifier 103.

The gain variable amplifier 106 controls the signal from which noise has been removed such that the signal reaches an appropriate level. The A/D converter 107 converts the output of the gain variable amplifier 106 (i.e., an analog signal) to a digital signal. The digital signal has a digital value (a sampling value ye). The FIR filter 108 equalizes the digital signal. The details of the FIR filter 106 will be described later.

The PLL 109 detects a zero cross point of the equalized digital signal and generates a clock which is in synchronization with the reproduction signal. The Viterbi decoding unit 110 decodes the equalized digital signal.

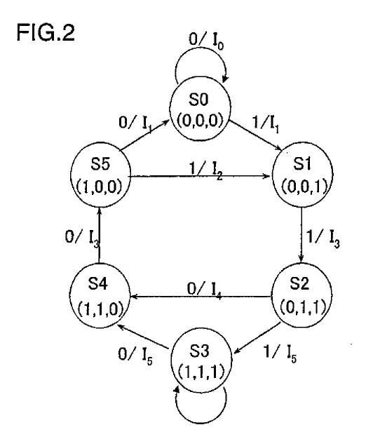

FIG. 2 shows state transitions of PR (1, 2, 2, 1) system modulated to RLL (1, 7) code.

Herein, Sn( a, b, c) denotes an n-th state. Arguments a, b and c are three bits for input demodulation data values before state n.. In “d/Iⱼ”, the target value Iⱼ is a value which the sampling value Yₖ may have when the state transition is made from state n to n+1, and the value d is a demodulation data value which is determined with the sampling value.

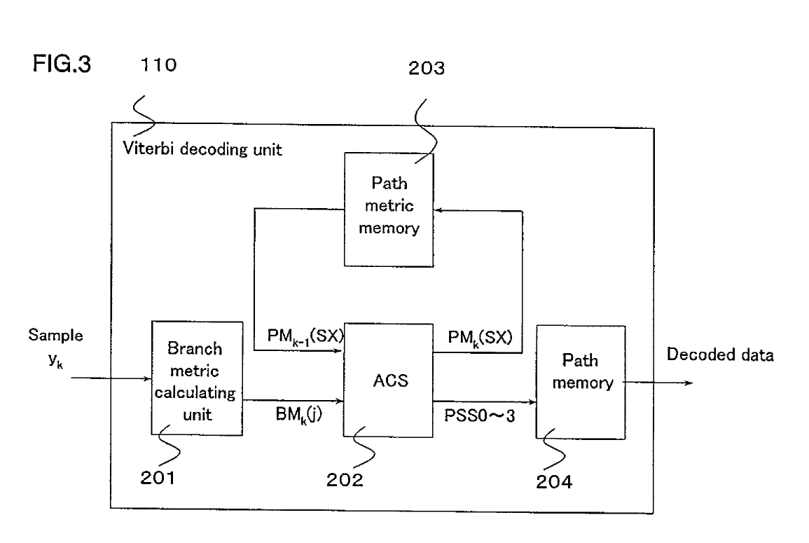

FIG. 3 shows a configuration of the Viterbi decoding unit 110.

The Viterbi decoding unit 110 includes a branch metric calculating unit 201 and an ACS (Add Compare Select) block 202, a path metric memory 203, and a path memory 204.

With reference to FIG. 2 and FIG. 3, the operation of the Viterbi decoding unit 110 will be described below.

The branch metric calculating unit 201 calculates a branch metric in accordance with the following Expression 4.

Expression 4:

BMₖ(j)=(yₖ−Iⱼ)²

where BMₖ(j) denotes a k-th branch metric.

The ACS block 202 selects a maximum likelihood path in accordance with the following Expression 5.

Expressions 5:

PMₖ(S0)=min[PMₖ₋₁(S0)+BMₖ(0), PMₖ₋₁(S5)+BMₖ(1)]

PMₖ₋₁(S0)+BMₖ(0)÷PMₖ₋₁(S5)+BMₖ(1) : PSS0=‘1’

PMₖ₋₁(S0)+BMₖ(0)<PMₖ₋₁(S5)+BMₖ(1) : PSS0=‘0’

PMₖ(S1)=min[PMₖ₋₁(S0)+BMₖ(1), PMₖ₋₁(S5)+BMₖ(2)]

PMₖ₋₁(S0)+BMₖ(1)≧PMₖ₋₁(S5)+BMₖ(2) : PSS1=‘1’

PMₖ₋₁(S0)+BMₖ(1)<PMₖ₋₁(S5)+BMₖ(2) : PSS1=‘0’

PMₖ(S2)=PMₖ₋₁(S1)+BMₖ(3)

PMₖ(S3)=min[PMₖ₋₁(S3)+BMₖ(6), PMₖ₋₁(S2)+BMₖ(5)]

PMₖ₋₁(S3)+BMₖ(6)≧PMₖ₋₁(S2)+BMₖ(5) : PSS2=‘1’

PMₖ₋₁(S3)+BMₖ(6)<PMₖ₋₁(S2)+BMₖ(5) : PSS2=‘0’

PMₖ(S4)=min[PMₖ₋₁(S3)+BMₖ(5), PMₖ₋₁(S2)+BMₖ(4)]

PMₖ₋₁(S3)+BMₖ(5)≧PMₖ₋₁(S2)+BMₖ(4) : PSS3=‘1’

PMₖ₋₁(S3)+BMₖ(5)<PMₖ₋₁(S2)+BMₖ(4) : PSS3=‘0’

PMₖ(S5)=PMₖ₋₁(S4)+BMₖ(3)

The value of the path memory 204 is updated based on the values of PSS0 to PSS3 selected by the ACS block 202. The path that has survived in the path memory 204 is decoded as the maximum likelihood path.

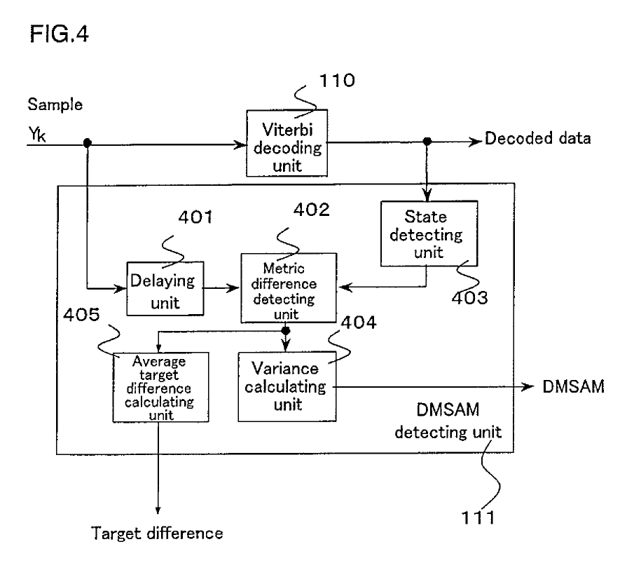

FIG. 4 shows a configuration of the DMSAM detecting unit 111.

The DMSAM detecting unit 111 includes a delaying unit 401 for delaying, by a predetermined period of time, the signal yᵢ used as a sampling value in order to detect path metric differences, a metric difference detecting unit 402 detecting the metric differences between metrics of selected paths and metrics of unselected paths for a pattern which has the shortest Euclidian distance, a pattern detecting unit 403 for detecting a pattern which has the shortest Euclidian distance, a variance calculating unit 404 for calculating a variance in the metric differences detected by the metric difference detecting unit 402, and an average target difference calculating unit 405 for calculating the difference between an average value of the metric differences and a target value.

ADMSAM value is an index based on the filtered signal and the decoded signal. The DMSAM detecting unit 111 detects a recording sequence which includes a path having the shortest Euclidian distance in the maximum likelihood decoding process, calculates differences (called “metric differences”) between the metrics of the selected paths and the metrics of the unselected paths when the detected reproduction signal sequence is decoded by the maximum likelihood decoding unit, and obtains a DMSAM value by calculating a variance of the metric differences.

In the demodulation system for the reproduction apparatus 100 according to Embodiment 1 of the present invention, there are eight patterns having the shortest Euclidian distance. The eight patterns are defined by the following Expressions 6.

Expressions 6;

Pattern 1: “0,1,1,X,0,0,0,” where X=don't care State transition (PA, PB) =(S₋₄)[S2]→S₋₃[S4]→S₋₂[S5]→S₋₁[S0]→S0[S0], S₋₄[S2]→S₋₃[S3]→S₋₂[S4]→S₋₁[S5]S₀[S0])

Pattern 2: “1,1,1,X,0,0,0,” where X=don't care State transition (PA, PB) =(S₋₄[S3]→S₋₃[S4]→S₋₂[S5]→S₋₁[S0]→S₀[S0], S₋₄[S3]→S₋₃[S3]→S₋₂[S4]→S₋₁[S5]→S₀[S0])

Pattern 3; “0,1,1,X,0,0,1,” where X=don't care State transition (PA, PS) =(S₋₄[S2]→S₋₃[S4]→S₋₂[S5]S₋₁[S0]→S₀[S1], S₋₄[S2]→S₋₃[S3]→S₋₂[S4]→S₋₁[S5]→S₀[S1])

Pattern 4: “1,1,1,X,0,0,1,” where X=don't care State transition (PA, PB) =(S₋₄[S3]→S₋₃[S4]→S₋₂[S5]→S₋₁[S0]→S₀[S1], S₋₄[S3]→S₋₃[S3]→S₋₂[S4]→S₋₁[S5]→S₀[S1])

Pattern 5: “0,0,0,X,1,1,0,” where X=don't care State transition (PA, PB) =(S₋₄[S0]→S₋₃[S0]→S₋₂[S1]→S₋₁[S2]→S₀[S4], S₋₄[S0]→S₋₃[S1]→S₋₂[S2]→S₋₁[S3]→S₀[S4])

Pattern 6: “1,0,0,X,1,1,0,” where X=don't care State transition (PA, PB) =(S₋₄[S5]→S₋₃[S0]→S₋₂[S1]→S₋₁[S2]→S₀[S4], S₋₄[S5]→S₋₃[S1]→S₋₂[S2]→S₋₁[S3]→S₀[S4])

Pattern 7: “0,0,0,X,1,1,1,” where X=don't care State transition (PA, PB) =(S₋₄[S0]→S₋₃[S0]→S₋₂[S1]→S₋₁[S2]→S₀[S3], S₋₄[S0]→S₋₃[S1]→S₋₂[S2]→S₋₁[S3]→S₀[S3])

Pattern 8: “1,0,0,X,1,1,1,” where X=don't care State transition (PA, PB) =(S₋₄[S5]→S₋₃[S0]→S₋₂[S1]→S₋₁[S2]→S₀[S3], S₋₄[S5]→S₋₃[S1]→S₋₂[S2]→S₋₁[S3]→S₀[S3])

With reference to FIG. 4, the operation of the DMSAM detecting unit 111 will be described below.

The pattern detecting unit 403 detects a pattern having the shortest Euclidian distance based on a signal which has either one of the two values and has been decoded by the Viterbi decoding unit 110 (see Expression 9).

The metric difference detecting unit 402 detects metric differences between the metrics of the selected paths and the metrics of the unselected paths in the pattern having the shortest Euclidian distance based on the detected pattern. At this time, the delaying unit 401 delays the signal yᵢ used as a sampling value by a predetermined period of time because the Viterbi decoding unit 110 causes a delay of the predetermined period of time during the decode.

The metric difference detecting unit 402 calculates the metric differences, DSAMV, between the metrics of the selected paths and the metrics of the unselected paths, in accordance with the following Expression 7.

$$Expression 7 \text{:}$$

$$\begin{matrix}DSAMV = {\sum }_{i = 0}^{- 3} {( {y}_{i} - {IB}_{i} )}^{2} - {\sum }_{i = 0}^{- 3} {( {y}_{i} - {IA}_{i} )}^{2} ( X = 0 ) \\ = {\sum }_{i = 0}^{- 3} {( {y}_{i} - {IA}_{i} )}^{2} - {\sum }_{i = 0}^{- 3} {( {y}_{i} - {IB}_{i} )}^{2} ( X = 1 )\end{matrix}$$

where (yᵢ-IAᵢ) denotes a branch metric of path A, and (yᵢ-IBᵢ) denotes a branch metric of path B.

The difference between the Euclidian distance of path A and the Euclidean distance of path B is defined by the following Expression 8.

$$Expression 8 \text{:}$$

$${d}_{min} = {\sum }_{i = 0}^{- 3} {( {IA}_{i} - {IB}_{i} )}^{2}$$

The variance calculating unit 404 calculates a DMSAM value based on the output of the metric difference detecting unit 402 (i.e.. DSAMV) and the shortest Euclidean distance dₘᵢₙ, in accordance with the following Expression 9.

$$Expression 9 \text{:}$$

$$DMSAM = \frac{\sqrt{\frac{1}{N} {\sum }_{k = 0}^{N} {( {DSAMV}_{k} - {d}_{min} )}^{2}}}{2 {d}_{min}}$$

When an average value of DSAMV values is dins the value of DMSAM is minimized (see Expression 9).

Thus, the operation of the DMSAM detecting unit 111 has been described above with reference to FIG. 4.

The value of DMSAM is largely influenced by the coefficients of the FIR filter. Accordingly, in an embodiment where the FIR filter is implemented by an adaptive filter which operates in accordance with an LMS algorithm, one of the problems is that the output from the adaptive filter diverges when an abnormal signal is input to the FIR filter. In addition, the filter characteristics of the FIR filter implemented by an adaptive filter vary in an extremely wide range in accordance with changes in the filter coefficients. As a result, the reproduction quality evaluating apparatus 400 according to a conventional technique is able to correct the output of an adaptive equalizing filter even if the individual differences among optical discs are large. Consequently, another problem is that it is not possible to use a DMSAM value as an index for evaluating the signal quality of optical discs, which are expected to have stable characteristics.

According to the reproduction apparatus 100 according to Embodiment 1 of the present invention, a variable range of the filter characteristics (the tap coefficients) of the FIR filter 108 is limited, and thus it is possible to perform the equalization to minimize the value of DMSAM.

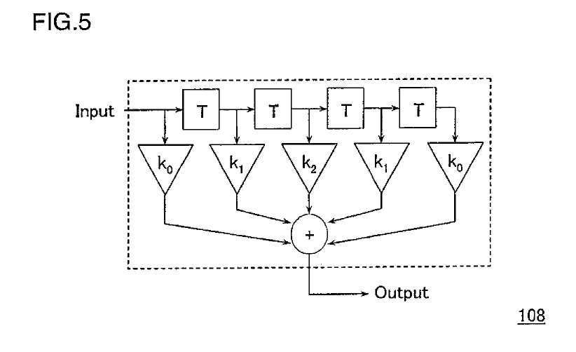

FIG. 5 shows a configuration of the FIR filter 108.

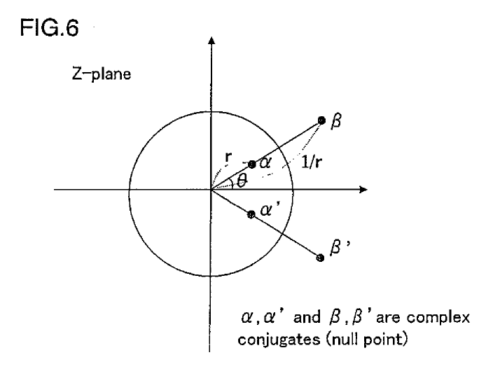

FIG. 6 shows filter characteristics of the FIR filter 108 on a z-plane.

With reference to FIG. 5 and FIG. 6, the operation of the FIR filter 108 will be described below in detail.

The FIR filter 108 includes five taps. In a normal FIR filter, because each of the five tap coefficients of the five taps can be set at any value, it is possible to configure the filter to have various characteristics. In the case where it is possible to limit the degree of freedom in setting the tap coefficients, it is possible to realize an FIR filter that operates within a certain range to increase its stability. It is also possible to use a DMSAM value as an index to define characteristics of optical discs, because it becomes possible to expect the characteristics of the FIR filter.

In the FIR filter 108, the degree of freedom in setting the filter characteristics (the tap coefficients) is limited. Specifically, the FIR filter 108 has characteristics satisfying a condition that the DMSAM value is equivalent to that of an adaptive FIR filter. In order to process reproduction signals without distortion, it is preferable that the FIR filter 108 has a flat group delay. Also, in order to avoid the influence from nonlinear distortion in the traveling direction of a light beam caused by recording conditions, it is preferable that the FIR filter 108 has symmetrical tap coefficients. Due to the restrictive conditions (to have symmetrical tap coefficients), the five tap coefficients (k₀, k₁, k₂, k₃, k₄) of the FIR filter 108 are limited to three-tap coefficients (k₀, k₁, k₂).

When the degree of freedom for the tap coefficients is limited from five to three, and the filter characteristics of the FIR filter 108 satisfying the restrictive conditions are expanded on a z-plane, complex conjugate solutions are arranged at a position of radius r and at a position of radius 1/r, at degree θ (see FIG. 6). When α, α′, β, and β′ represent the solutions on the z-plane, α, α′, β, and β′ can be represented by the following Expressions 10.

$$Expressions 10 \text{:}$$

$$α , {α}^{′} = r ( cos θ \pm j sin θ )$$

$$β , {β}^{′} = \frac{1}{r} ( cos θ \pm j sin θ )$$

The function of the FIR filter 108 is defined by the following Expression 11.

Expression 11:
z⁴(1−αz⁻¹)(1−βz⁻¹)(1−α′z⁻¹)(1−62 ′z⁻¹)

The tap coefficients of the FIR filter 108 are calculated based on Expressions 10 and Expression 11 (see Expressions 12 below).

$$Expressions 12 \text{:}$$

$${k}_{0} = {k}_{4} = \frac{1}{2 + 2 ( \frac{1}{r} + r ) cos θ + 4 {cos}^{2} θ + {r}^{2} + \frac{1}{{r}^{2}}}$$

$${k}_{1} = {k}_{3} = \frac{2 ( \frac{1}{r} + r ) cos θ}{2 + 2 ( \frac{1}{r} + r ) cos θ + 4 {cos}^{2} θ + {r}^{2} + \frac{1}{{r}^{2}}}$$

$${k}_{2} = \frac{4 {cos}^{2} θ + {r}^{2} + \frac{1}{{r}^{2}}}{2 + 2 ( \frac{1}{r} + r ) cos θ + 4 {cos}^{2} θ + {r}^{2} + \frac{1}{{r}^{2}}}$$

In this case, a gain at the 0 Hz frequency is 1. It should be noted that because the gain of the reproduction apparatus 100 is corrected by the variable gain amplifier 106, there is no problem even if the gain at the 0 Hz frequency is 1.

Due to the restrictive conditions described above, the tap coefficients of the FIR filter 108 can be represented by two variables, namely (r, θ). Thus, it is possible to decrease the degree of freedom to 2.

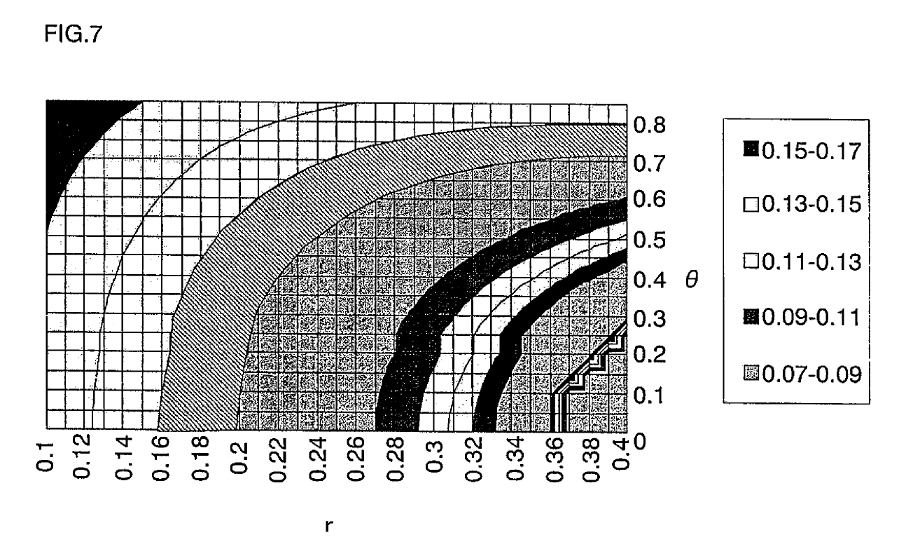

FIG. 7 shows a relationship between the filter characteristics of the FIR filter 108 and a DMSAM value. The horizontal axis indicates value r, and the vertical axis indicates value θ. The NA (Numerical Aperture) of the reproduction apparatus 100 is 0.85. The wavelength of the light beam is 405 nm.

The DMSAM value is minimized in an area where the a predetermined relationship is satisfied with respect to value θ and the value r. When the DMSAM value is minimized, an FIR filter is configured to satisfy the optimal reproduction condition. In this case, the DMSAM value is 7.9%, whereas a DMSAM value is 8.2% in an FIR filter according to a conventional LMS method.

Thus, the filter characteristics of the FIR filter 108 according to Embodiment 1 of the present invention are better than those of the conventional FIR filter. This is because the conventional FIR filter performs the adaptive process so that the reproduction level reaches a desired level for all the patterns, whereas the FIR filter 108 changes the filter characteristics so that the DMSAM value is minimized. According to the conventional technique, the characteristics of the FIR filter during the reproduction are adjusted so that all the reproduction levels reach a desired level. On the other hand, according to Embodiment 1 of the present invention, only the pattern having the shortest Euclidean distance (i.e.. a pattern fox which an error is most likely to occur) is detected, and the characteristics of the FIR filter 108 are adjusted so that the level of the reproduction signal for the detected pattern reaches a desired level. In Embodiment 1 of the present Invention, the characteristics of the FIR filter 108 are optimized for only the patterns, for which an error occurs with highest possibility. As a result, it is possible to realize a reproduction system which reduces the number of errors.

Even when θ=0 is satisfied, it is possible to minimize the DMSAM value by optimally controlling the value r. Accordingly, it is possible to adjust the characteristics of the FIR filter to a sufficient level for the reproduction process by setting θ so as to satisfy θ=0 and controlling only the value r (see FIG. 7). The tap coefficients, when θ=0 is satisfied, can be represented by the following Expressions 13.

$$Expressions 13 \text{:}$$

$${k}_{0} = {k}_{4} = \frac{1}{6 + 2 ( \frac{1}{r} + r ) + {r}^{2} + \frac{1}{{r}^{2}}}$$

$${k}_{1} = {k}_{3} = \frac{2 ( \frac{1}{r} + r )}{6 + 2 ( \frac{1}{r} + r ) + {r}^{2} + \frac{1}{{r}^{2}}}$$

$${k}_{2} = \frac{4 + 1 {r}^{2} + \frac{1}{{r}^{2}}}{6 + 2 ( \frac{1}{r} + r ) + {r}^{2} + \frac{1}{{r}^{2}}}$$

As described above, in the reproduction apparatus 100 according to Embodiment 1 of the present invention, it is possible to determine the characteristics of the FIR filter 108 by controlling only the value r. In addition, it is possible to realize a DMSAM value which is sufficiently small, in spite of the arrangement where the degree of freedom of the FIR filter 108 is greatly limited. It should be noted that it is preferable to set the value r to be within the range of 0.21≦r≦0.27 so that the DMSAM value is equal to or lower than 9% (see FIG. 7).

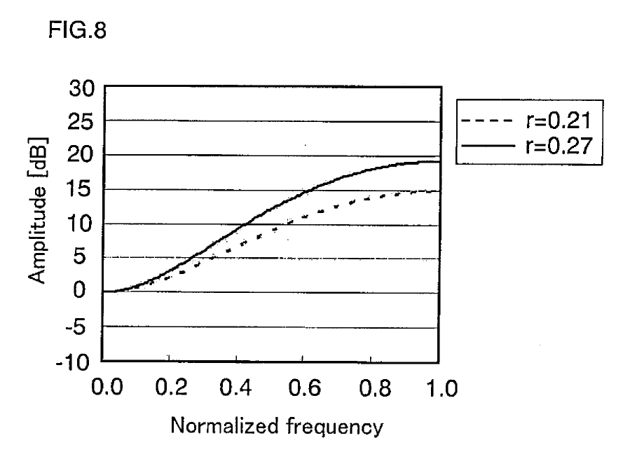

FIG. 8 shows the frequency characteristics of the FIR filter 108.

The horizontal axis indicates the normalized frequency of the FIR filter 108. A half of the clock frequency of the FIR filter 108 is represented by 1. The vertical axis indicates the amplitude in “dB”.

By controlling the value r, it is possible to limit the range in which the characteristics of the FIR filter vary to a smaller range. According to the reproduction apparatus 100, by the coefficient controlling unit 112 controlling the tap coefficients such that 0.21≦r≦0.27 is satisfied, the DMSAM value is minimized.

As described above, since the range within which the value r is controlled is limited, the characteristics of the FIR filter 108 do not greatly vary. Thus, it is possible to achieve a stable operation even if there are some defects. With this arrangement, it is possible to obtain a DMSAM value enabling better characteristics than those of the conventional FIR filter, while the range in which the characteristics of the FIR filter 108 vary is limited to a smaller range. According to the reproduction apparatus 100 according to Embodiment 1 of the present invention, it is possible to evaluate the signal quality of recording medium which requires stable characteristics.

According to Embodiment 1 of the present invention, the coefficient controlling unit 112 controls the tap coefficients such that θ=0 and 0.21≦r≦0.27 are satisfied, and the characteristics of the FIR filter 108 are limited within a range that includes the smallest value of DMSAM. It should be noted, however, that θ=0 is not necessarily required. It is possible to change the value r and to select the value r for any value of θ such that the DMSAM value is minimized, as long as the range within which the value r varies includes the smallest value of DMSAM. By the coefficient controlling unit 112 controlling the value r within the range, it is possible to obtain the smallest DMSAM value while limiting the range in which the characteristics of the FIR filter may vary to a smaller range. As a result, it is possible to optimally reproduce data.

Thus, the reproduction apparatus 100 according to the Embodiment 1 of the present invention has been described with reference to FIG. 1 to FIG. 8.

### Embodiment 2

According to Embodiment 1 of the present invention, the FIR filter 108 has constant group delay characteristics and includes symmetrical filter coefficients, and the filter coefficients of the FIR filter 108 are controlled to be within a predetermined mange, such that the DMSAM value includes an optimal DMSAM value. According to Embodiment 2 of the present invention, a range within which the filter coefficients of an FIR filter are controlled is controlled using the conventional LMS method, and the range within which the filter coefficients are controlled is limited to a predetermined range.

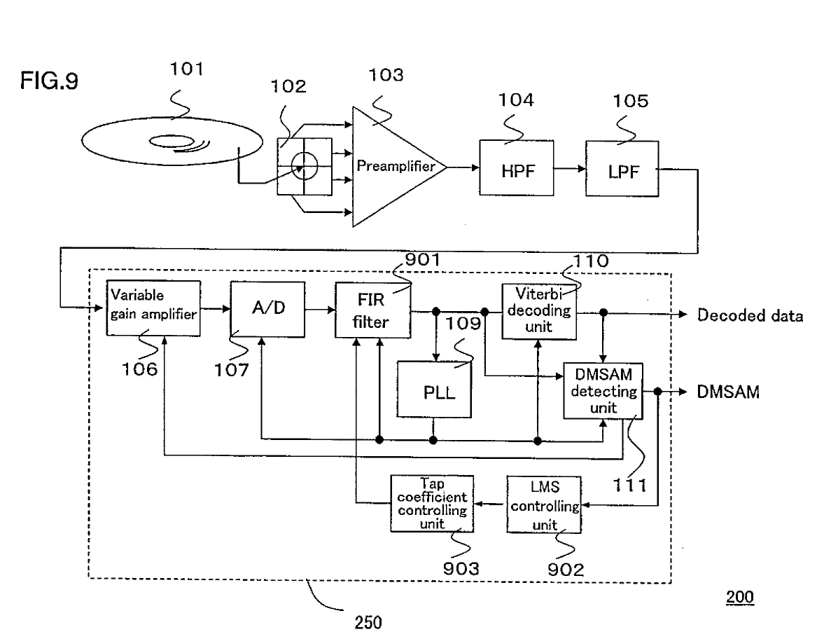

FIG. 9 shows a configuration of a reproduction apparatus 200 according to Embodiment 2 of the present invention. In FIG. 9, the same reference numerals are applied to the same elements in the reproduction apparatus 100 shown in FIG. 1, and the description thereof will be omitted.

The reproduction apparatus 200 is configured so that an optical disc 101 can be inserted therein. There production apparatus 200 includes a PIN diode 102, a preamplifier 103, a high pass filter 104, a Butterworth low pass filter 105, and an evaluating apparatus 250.

The evaluating apparatus 250 includes a variable gain amplifier 106, an A/D converter 107, an FIR filter 901, a PLL 109, a Viterbi decoding unit 110, a DMSAM detecting unit 111, an LMS controlling unit 902, and a tap coefficient controlling unit 903.

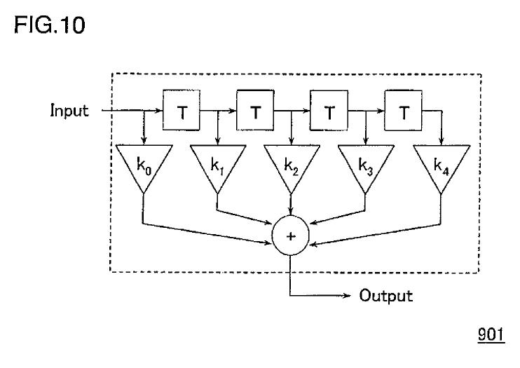

FIG. 10 shows a configuration of the FIR filter 901.

The FIR filter 901 includes five taps. The five taps of the FIR filter 901 have tap coefficients (k₀, k₁, k₂, k₃, k₄).

The operation of the FIR filter 901 will be described in detail below with reference to FIG. 9 and FIG. 10.

The LMS controlling unit 902 controls the tap coefficients (k₀, k₁, k₂, k₃, k₄) of the FIR filter 901 using the LMS method such that the DMSAM value detected by the DMSAM detecting unit 111 is minimized. Specifically, the LMS controlling unit 902 sequentially updates the tap coefficients (k₀, k₁, k₂, k₃, k₄) of the FIR filter 901.

The LMS controlling unit 902 controls the tap coefficients of the FIR filter 901 appropriately and determines the tap coefficients such that the DMSAM value is minimized. By reproducing signals under a condition which is appropriately adjusted in advance, it is possible to determine the tap coefficients (k₀, k₁, k₂, k₃, k₄) such that the output of the FIR filter 901 appropriately converges.

In Embodiment 2 of the present invention, a signal reproduced under a stressed condition, which is expected during the operation of a drive, is given to the FIR filter 901 in advance, and a range of the tap coefficients (k₀, k₁, k₂, k₃, k₄) are determined. For example, such a stress may be defocus and the variation in spherical aberration due to inclination of a disc during the operation of the drive. Alternatively, the stress may be the change in the power and the variation in the strategy during the recording operation.

By operating the LMS controlling unit 902 in advance with the signal reproduced under the stressed condition, the range within which the tap coefficients (k₀, k₁, k₂, k₃, k₄) are controlled is determined It is possible to easily determine the range within which the tap coefficients are controlled by conducting an experiment in advance when the drive is designed. The tap coefficient controlling unit 903 controls the tap coefficients (k₀, k₁, k₂, k₃, k₄) within the range determined based on the experiment conducted in advance. Accordingly, the filter characteristics of the FIR filter 901 do not vary greatly outside of a variable range which is expected at a design stage in advance. Thus, the reproduction apparatus 200 can stably operate even if there are some defects.

According to the reproduction apparatus 200 according to Embodiment 2 of the present invention, it is possible, like with the arrangements of the reproduction apparatus 100, to limit the range in which the filter characteristics of the FIR filter 901 vary to a predetermined range, and to obtain an optimal DMSAM value. As a result, the reproduction apparatus 200 according to Embodiment 2 of the present invention can evaluate quality of signals.

Thus, Embodiment 1 and Embodiment 2 of the present invention have been described with reference to FIG. 1 to FIG. 10.

For example, in the example described with reference to FIG. 1 and FIG. 9, the evaluating apparatus 150 or the evaluating apparatus 250 corresponds to an “evaluating apparatus including a digital filter”; the FIR filter 108 or the FIR filter 901 corresponds to a “filter for filtering a signal in accordance with one or more tap coefficients”; the DMSAM detecting unit 111 corresponds to a “detecting section for detecting an index to be used for evaluating quality of the signal based on the filtered signal”; and the coefficient controlling unit 112 or the LMS controlling unit 902 and the tap coefficient controlling unit 903 corresponds to a “controlling section for controlling the one ox more tap coefficients of the digital filter to be within a predetermined range such that a value of the detected index includes an optimal value of the index.”

However, the optical disc apparatus of the present invention is not limited to an apparatus shown in FIG. 1, As long as the functions of the elements described above are achieved, any optical disc apparatus having any configuration should be interpreted to fall within the scope of the present invention.

For example, the index to be used for evaluating the quality of the signal is not limited to a DMSAM value. It is possible to use any other index as long as it is possible to evaluate the quality of the signal using the other index. For example, the other index may be SAM (Sequenced Amplitude Margin) and SAMER (Sequenced Amplitude Margin Error).

The SAM indicates differences (metric differences) between the metrics of the selected paths and the metrics of the unselected paths within a Viterbi decoding unit. The larger a value of the SAM is, the higher the quality of a reproduction signal is.

The SAMER indicates the number of metric differences, which are lower than or equal to a predetermined threshold value, from the differences (metric differences) between the metrics of the selected paths and the metrics of the unselected paths within a Viterbi decoding unit. The smaller a value of the SAMER is, the higher the quality of a reproduction signal is.

When the SAM is used as an index, the reproduction apparatus 100 includes a SAM detecting unit, in addition to the DMSAM detecting unit 111, or instead of the DMSAM detecting unit 111, for example. The SAM detecting unit detects the differences between the metrics of the selected paths and the metrics of the unselected paths within the Viterbi decoding unit.

When SAMER is used as an index, the reproduction apparatus 100 includes a SAMER detecting unit, in addition to the DMSAM detecting unit 111, or instead of the DMSAM detecting unit 111, for example. The SAMER detecting unit detects the differences between the metrics of the selected paths and the metrics of the unselected paths within the Viterbi decoding unit, and counts the number of the differences (detected results) which are lower than or equal to the predetermined threshold value.

The conventional reproduction signal quality evaluating apparatus 400 controls the amplitude of the reproduction signal such that the amplitude of the reproduction signal is at a predetermined constant level. It should be noted, however, that the controlling of the amplitude in this case is not necessarily performed in order to minimize the DMSAM value.

For example, the reproduction apparatus 100 according to Embodiment 1 of the present invention can control the amplitude of the reproduction signal such that the DMSAM value approaches an optimal DMSAM value.

Hereinafter, another embodiment of the present invention will be described with reference to FIG. 1, FIG. 4 and FIG. 9. In this embodiment, each of the reproduction apparatus 100 and the reproduction apparatus 200 controls the amplitude of a reproduction signal such that the DMSAM value is minimized.

The DMSAM detecting unit 111 includes a variance calculating unit for calculating a DMSAM value, which is a variance of DSAMV values, and an average target difference calculating unit 405 for calculating a difference between the average of DSAMV values and dₘᵢₙ.

The average target difference calculating unit 405 detects the difference between the average of DSAMV values and dₘᵢₙ. The average target difference calculating unit 405 outputs a difference signal indicating the detected difference (i.e.. an error) to the variable gain amplifier 106. The variable gain amplifier 106 controls the amplitude of the reproduction signal such that the DMSAM value approaches an optimal DMSAM value. For example, the variable gain amplifier 106 controls the amplitude of the reproduction signal such that the average of the DSAMV values approaches dₘᵢₙ. As a result, the average of the DSAMV values comes to be the same as dₘᵢₙ, and it is possible to control the amplitude such that the DMSAM value is minimized in a better manner compared to the conventional amplitude control. According to the amplitude control of the present invention, the DMSAM value is improved by approximately 1%, compared with the conventional amplitude control.

As described above with reference to FIG. 1 and FIG. 4, the reproduction apparatus 100 according to Embodiment 1 of the present invention controls the amplitude of the reproduction signal such that the DMSAM value is minimized. In this example, the amplitude of the reproduction signal is controlled based on the difference between the average values output from the DMSAM detecting unit. However, the control of the amplitude of the reproduction signal is not limited to this example. It is possible to control the amplitude of the reproduction signal through an AGC process performed by the reproduction signal itself or through an alignment of the amplitude by digitally multiplying a sampling point, after an A/D conversion, by a coefficient.

Each element described in the embodiments shown in FIG. 1 and FIG. 9 maybe implemented by hardware, software, or the combination of hardware and software. It is possible to perform an evaluation process according to the present invention regardless of whether each element is implemented by software, hardware, or the combination of hardware and software.

The evaluation process according to the present invention includes the steps of “filtering a signal in accordance with one or more tap coefficients of a digital filter”; “detecting an index to be used for evaluating quality of the signal based on the filtered signal”; and “controlling the one or more tap coefficients of the digital filter to be within a predetermined range such that the detected index includes an optimal value of the index”. The evaluation process according to the present invention may include any procedures as long as it is possible to execute the steps described above.

The evaluating apparatus according to the present invention may store therein an evaluation processing program for executing the functions of the evaluating apparatus.

The evaluation processing program may be stored in a storage unit included in the evaluating apparatus before a computer is shipped. Alternatively, it is possible to store an access process into the storage unit after the computer is shipped. For example, it is possible to have an arrangement in which a user downloads an evaluation process program from a specific website on the Internet for a fee, or for free, and installs the downloaded program onto a computer. In the case where the evaluation process is recorded on a computer-readable recording medium such as a flexible disc, a CD-ROM, or a DVD-ROM, the evaluation process may be installed onto a computer with the use of an input device. In such a case, the installed evaluation process will be stored in a storage unit.

The following Item 1 and Item 2 are also within the scope of the present invention.

Item 1: An evaluating apparatus for evaluating quality of a signal, comprising:

a maximum likelihood decoding unit for performing a maximum likelihood decoding on the signal and generating a decoded signal indicating a result of the maximum likelihood decoding;

a detecting unit for detecting an index to be used for evaluating the quality of the signal based on the signal and the decoded signal; and

an amplitude controlling unit for controlling an amplitude of the signal such that a value of the detected index approaches an optimal value of the index.

Item 2: An evaluating method for evaluating quality of a signal, comprising the steps of:

performing a maximum likelihood decoding on the signal and generating a decoded signal indicating a result of the maximum likelihood decoding;

detecting an index to be used for evaluating the quality of the signal based on the signal and the decoded signal; and

controlling an amplitude of the signal such that a value of the detected index approaches an optimal value of the index.

As described above, the present invention is exemplified by the use of its preferred embodiments. However, the present invention should not be interpreted solely based on the embodiments described above. It is understood that the scope of the present invention should be interpreted solely based on the claims. It is also understood that those skilled in the art can implement equivalent scope of technology, based on the description of the present invention and common knowledge from the description of the detailed preferred embodiments of the present invention Furthermore, it is understood that any patent, any patent application and any references cited in the present specification should be incorporated by reference in the present specification in the same manner as the contents are specifically described therein.

### INDUSTRIAL APPLICABILITY

According to the evaluating apparatus and the evaluating method of the present invention, it is possible to minimize a DMSAM value to the same extent as in a case where a decoding is performed by an adaptive equalizing filter using the conventional LMS, without greatly changing the characteristics of the FIR filter.

According to the present invention, it is possible to limit the characteristics of a signal equalizing unit, which performs processing before the Viterbi decoding, to be within a predetermined range Thus, it is possible to use a DMSAM value, which cannot be used according to the conventional technique, for the purpose of evaluating signals of a recording medium. Also, in the reproduction apparatus according to the present invention, it is possible to limit the adaptive range of the signal equalizing unit to be within a predetermined range. Thus, it is possible to configure a stable reproduction system even when there is a signal loss due to a defect in a recording medium.

1. An evaluating apparatus comprising a digital filter for filtering a signal in accordance with one or more tap coefficients of the digital filter,
the evaluating apparatus further comprising:
a detecting section for detecting an index to be used for evaluating quality of the signal based on the filtered signal; and
a controlling section for controlling the one or more tap coefficients of the digital filter to be within a predetermined range such that a value of the detected index includes an optimal value of the index.

2. An evaluating apparatus according to claim 1, wherein
the digital filter includes a plurality of taps, and
the controlling section controls a plurality of tap coefficients of the plurality of taps such that the plurality of taps such that the plurality of tap coefficients are symmetrical.

3. An evaluating apparatus according to claim 1, further comprising:
a maximum likelihood decoding section for performing a maximum likelihood decoding on the filtered signal and for generating a decoded signal indicating a result of the maximum likelihood decoding, wherein
the detecting section detects the index based on the filtered signal and the decoded signal,
the digital filter includes a first tap, a second tap, a third tap, a fourth tap, and a fifth tap, and
the controlling section controls tap coefficient kₒ of the first tap, tap coefficient k₁ of the second tap, tap coefficient k₂ of the third tap, tap coefficient k₃ of the fourth tap, and tap coefficient k₄ of the fifth tap, in accordance with the following Expressions 14, 15, and 16:
$$Expression 14 \text{:}$$
$${k}_{0} = {k}_{4} = \frac{1}{6 + 2 ( \frac{1}{r} + r ) + {r}^{2} + \frac{1}{{r}^{2}}}$$
$$Expression 15 \text{:}$$
$${k}_{1} = {k}_{3} = \frac{2 ( \frac{1}{r} + r )}{6 + 2 ( \frac{1}{r} + r ) + {r}^{2} + \frac{1}{{r}^{2}}}$$
$$Expression 16 \text{:}$$
$${k}_{2} = \frac{4 + {r}^{2} + \frac{1}{{r}^{2}}}{6 + 2 ( \frac{1}{r} + r ) + {r}^{2} + \frac{1}{{r}^{2}}}$$
where a frequency characteristic of the digital filter is controlled by r parameter.

4. An evaluating apparatus according to claim 3, wherein
a relationship of 0.21≦r≦0.27 is satisfied.

5. An evaluating method comprising the steps of:
filtering a signal in accordance with one or more tap coefficients of a digital filter;
detecting an index to be used for evaluating quality of the signal based on the filtered signal; and
controlling the one or more tap coefficients of the digital filter to be within a predetermined range such that the detected index includes an optimal value of the index.

6. An evaluating apparatus for evaluating quality of a signal, comprising:
a maximum likelihood decoding unit for performing a maximum likelihood decoding on the signal and generating a decoded signal indicating a result of the maximum likelihood decoding;
a detecting unit for detecting an index to be used for evaluating the quality of the signal based on the signal and the decoded signal; and
an amplitude controlling unit for controlling an amplitude of the signal such that a value of the detected index approaches an optimal value of the index.

7. An evaluating method for evaluating quality of a signal, comprising the steps of:
performing a maximum likelihood decoding on the signal and generating a decoded signal indicating a result of the maximum likelihood decoding;
detecting an index to be used for evaluating the quality of the signal based on the signal and the decoded signal; and
controlling an amplitude of the signal such that a value of the detected index approaches an optimal value of the index.
